(19) United States
(12) Patent Application Publication
(10) Pub. No.: US 2005/0117237 A1
(43) Pub. Date: Jun. 2, 2005

(54) Articulated arm of the rear mirror

(76) Inventor: Slavko Medimurec, Grosuplje (SI)

Correspondence Address: Timothy J Ziolkowski;Ziolkowski Patent Solutions Group, 14135 North Cedarburg Road, Mequon, WI, 53097-1416, US

(21) Appl. No.: 10/491,601

(22) PCT Filed: Oct. 1, 2002
(86) PCT No.: PCT/SI02/00022

(30) Foreign Application Priority Data
Oct. 1, 2001 (SI) P-200100257

(51) Int. Cl. G02B 7/182

(52) U.S. Cl. 359/879; 359/871

(57) ABSTRACT

The invention refers to the articulated arm of the rear mirror for cars, bicycles and/or to that of an additional internal car rear mirror, suitable for efficient mounting either on the handlebar or inside the car and allowing for simple adjustment of the viewing position. The articulated rear mirror arm, referred to in this invention allows for simple adjustment and arresting of the selected position by means of the articulated parts including the rod shaped structure of the carrier element (1, 14), the intermediate connection element (2, 15) and the fixing element (3, 16). The mirror (4) is with its frame (5) fixed to one end of the intermediate connection element, thereby forming an articulation.

### BACKGROUND OF THE INVENTION

The invention relates to a rotatable connection of a rear-view mirror arm and to modes of fixing it to a vehicle like all vehicles in road traffic, for instance cars, bicycles, motorcycles and especially wheelchairs of all types.

### PRIOR ART

An additional rear-view mirror to be used in vehicles was described in our previous Slovenian patent application No. P-200100233, the joint support of this mirror is also described in our Slovenian design application No. M-200150005.

The adjustment of a rear-view mirror mostly depends on the shape of the support and its mode of being fixed to a vehicle.

According to WO 01/28816 A2 (Medimurec) the connection element of the mirror consists of a carrier element, an intermediate connection element and a fixing part, whereat the carrier element and the connection element are provided with slightly conical springs ending in a thick edge. The springs fit into a corresponding hole on the other end to be joined.

A deficiency of this invention is that the conical spring provided on one conical element decreases the friction between both elements so that the vibrations of the vehicle on which the mirror is mounted reposition the mirror. Nor can the mentioned decreased friction compensate a temperature difference of nearly 60° C. between winter and summer to which the mirror is exposed.

Further, the invention according to FR 72 06224 (Meyer) describes a connection sistem of a mirror consisting of two elements corresponding to each other by conical parts, which are fixed by a radial groove in one part and a corresponding radial ring on the other part. The friction between the said parts is increased by a third element, namely a radial spring mounted on or in one of the said parts.

The deficiency of the decreased friction of the invention according to WO 01/28816 A2 is solved by this invention involving the third element, namely the radial spring, whereas the connecting elements themselves i.e. the radial groove and the radial ring do not create enough force resulting in friction. Yet sucha construction is much more complicated for assembling, especially in the sense of automatisation or robotisation thereof.

There is a known embodiment where, simultaneously with screwing the support of a mirror to a vehicle, also the connection in which the mirror can be adjusted is fixed. A disadvantage of this solution lies in the co-dependence of two important functions of the support of the mirror. If we want to set the position of the mirror positioned on such a support, we must first unscrew the support, which loosens the point in which the mirror together with its support is roughly adjusted. This embodiment also limits the mode of fastening the support to a vehicle.

### DESCRIPTION OF THE TECHNICAL PROBLEM

Rear-view mirrors are installed on.-every vehicle. Also wheelchairs can be regarded as. vehicles, though there is no regulation as yet that would require the fitting of rear-view mirrors to wheelchairs.

It is superfluous to explain that a rear-view mirror on wheelchairs is a necessity because the users of wheelchairs are handicapped persons having trouble turning their upper body and their neck and thus finding it hard to look back—if they do so, they need substantially more time.

Rear-view mirrors as well as additional rear-view mirrors allow the handicapped persons to have better view of the road, thus contributing to a higher level of safety in traffic.

### SHORT DESCRIPTION OF DRAWINGS

FIG. 1: rotatable connection of a rear-view mirror arm in cross-section;

FIG. 2: schematic view of the first mode of fastening it to a vehicle, with an open ring (22);

FIG. 3: schematic view of the second mode of fastening it to a vehicle, with a closed ring with a screw (33);

FIG. 4: schematic view of the third mode of fastening it to a vehicle, with an open angle clamp and a screw (44).

### DESCRIPTION OF THE INVENTION

The present invention concerns a rotatable connection of a rear-view mirror arm (1) consisting of two parts (2, 3) positioned coaxially and separated by contact panels (2a, 3a). The lower part (2) of the rotatable connection is fastened to a vehicle, whereas the upper part (3) of the rotatable connection is pivotably embedded in the said lower part.

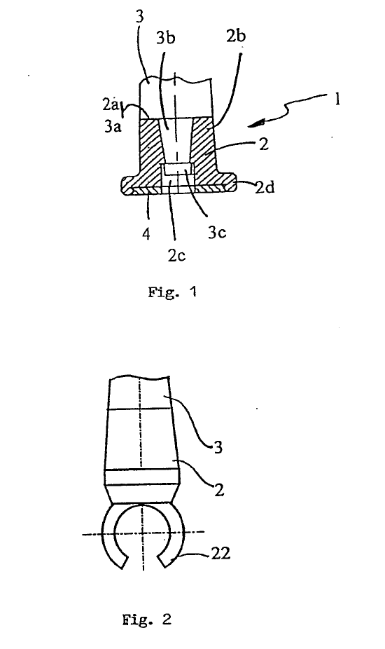

As shown in FIG. 1, the lower part (2) has a central hole which is conical in the upper part (2b), i.e. from the contact panel (2a) downwards, and represents the female part of the bearing and then passes stepwise towards the lower part (2c) of the hole, which is cylindrical.

Below its contact panel (3a) the upper part (3) has a downward facing male part of the bearing, which is conical in its upper part (3b) and at its lower part it passes stepwise into a conical final part (3c).

The mentioned conical parts (2b, 3b) fit tightly with regard to their cones as well as to their lengths.

With the conical part (3b) being pushed into the conical hole (2b) to the end, the upper part of the connection is stuck in the lower cylindrical part of the hole (2c) by means of the conical final part (3c). The two parts are now connected and mutually rotatingly fixed without any looseness.

Since the conical final part 3c is, with regard to the conical part 3b, larger and solid, it produces enough rigidity to ensure a satisfying friction between the conical parts 2b and 3b in all temperature intervals in which the mirror might be used.

Both parts of the rotatable connection can be of any metal (e.g. Al) or plastic material (e.g. ABS) resistant to temperature changes between approximately −50° C. to 90° C. and to atmospheric influences like corrosion and it is also important that its specific mass is not too high. The recommended specific mass of the material should not exceed 2,900 kg/m³.

The external shape of the rotatable connection (1) in the shown embodiment is conical—the curved surface of the lower part (2) continuously passes into the curved surface of the upper part (3). The external shape of the rotatable connection can also be cylindrical or prismatic or of any other suitable shape like for instance four-leaved clover and the like.

At the bottom, the lower part (2) of the rotatable connection can be broadened into a flat, preferably circular base (2d) where a fixed fastening metallic plate (4) can be inserted. The base can also be angular or have some other suitable shape.

Moreover, the present invention refers to the modes of fastening the arm with the above rotatable connection to a vehicle.

The invention offers several modes of fastening the arm to a vehicle.

This can be done by the means of an open ring as shown in FIG. 2. This solution is especially suitable for a quick temporary mounting of the arm.

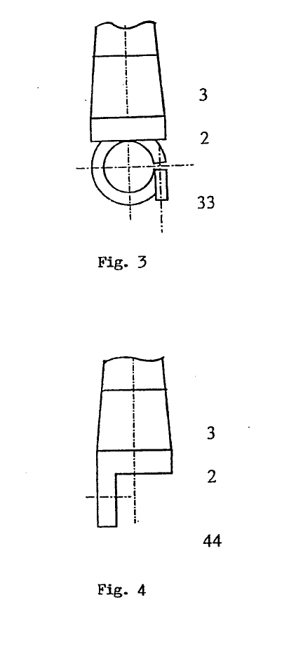

It can also be done by means of a closed ring with a screw (FIG. 3) or for instance by means of an open angular clamp and a screw (FIG. 4) or by an adjustable closed clamp operating on the principle of a vice (not shown in the drawings).

The first two mentioned solutions are especially suitable for mounting to a tube which may be round like on bicycles. It may also have another cross-section e.g. polygonal.

The other two solutions, namely with the open or closed clamp (vice), are especially suitable for mounting to certain spots on wheelchairs. The embodiment with a closed clamp is appropriate to be fixed to a variety of flat bases of wheelchairs, especially near and below the arm rest. With these bars having various dimensions, it is appropriate for such a clamp to be adjustable.

The open angular clamp is suitable for mounting to a bar with machined threaded holes (from M6 to M10)—the clamp only needs to be screwed in. Said threaded holes are prefabricated in horizontal bars of some wheelchairs and are intended for other auxiliary equipment to be screwed in. Should no holes be available or should they all be occupied, the manufacturing of such a hole is a relatively simple procedure and can be performed by a metal worker or a person skilled in the art.

This description presents the invention only in a few variants and it is understood that the description encompasses all its variants and embodiments.

1. A rotatable connection of a rear-view mirror arm comprising a lower part and an upper part, whereat the upper part is pivotably and tightly fixed in a hole of the lower part and the parts are coaxial and a male part of the upper part and a female part of the lower part are conical, corresponding to each other and tightly fitting to each other, yet still allowing a forced rotation around the common axis of the connection, wherein the male conical part is extended to a final part located in a lower end part, which is extended in the narrower end of a contact panel and has stepwise a larger diameter than the contact panel at the narrower end, whereat the final part is substantially cylindrical or polygonal having a larger diameter than the conical part at the narrower end and a height of approximately one half of the diameter of the end part.

2. The rotatable connection of the rear-view mirror arm of claim 1, wherein the final part is solid and made together with the conical part as a unit of the same material.

3. A rotatable mirror arm mount assembly comprising:
a mount bracket having a recess therein;
a mirror bracket having a stem portion constructed to be snuggly received in the recess of the mount bracket wherein the mirror bracket is rotatable about a common axis of the mount bracket; and
a nipple formed about an end of the stem portion and snuggly engaged by a ledge formed in the recess of the mount bracket.

4. The mount assembly of claim 3 wherein the stem portion and the recess have a conical cross-section.

5. The mount assembly of claim 3 wherein the nipple has a cylindrical cross-sectional shape.

6. The mount assembly of claim 3 wherein the nipple has a polygonal cross-sectional shape.

7. The mount assembly of claim 3 wherein the mount bracket and mirror bracket are formed from at least one of a metal material and a plastic material.

8. The mount assembly of claim 3 wherein the mount bracket further comprises a ring portion extending from an end of the mount bracket generally opposite an end of the mount bracket facing the mirror bracket.

9. The mount assembly of claim 8 wherein the ring portion is C-shaped.

10. The mount assembly of claim 8 further comprising a fastener constructed to pass through the ring portion.

11. The mount assembly of claim 3 further comprising a lip formed about an outer diameter of an end of the mount bracket and having an outer diameter that is greater than an outer diameter of the mirror bracket.

12. The mount assembly of claim 3 wherein the mirror bracket further comprises a lip formed about an end of the stem portion generally opposite the nipple.

13. A mirror mount assembly comprising:
a first bracket constructed to be connected to a mirror and having a body portion and a stem portion;
a second bracket constructed to be mounted to a surface and having an opening passing therethrough, the opening having a first conical portion and a second portion;
a nipple formed about an end of the stem portion of the first portion and constructed to pass through the conical portion of the opening and engage the cylindrical portion of the second bracket; and
wherein an end of the body portion contacts an end of the second bracket when the nipple is engaged with the cylindrical portion; and
means for mounting the second bracket to the surface extending from the second bracket generally parallel to an axis of rotation of the first bracket.

14. The mirror mount assembly of claim 13 wherein the second portion of the opening has a shape that substantially matches a shape of the nipple.

15. The mirror mount assembly of claim 14 wherein the shape of the nipple is at least one of a cylindrical shape and a polygonal shape.

16. The mirror mount assembly of claim 13 wherein the first bracket is constructed from at least one of a metal material and a plastic material.

17. The mirror mount assembly of claim 13 wherein the second bracket is constructed from at least one of a metal material and a plastic material.

18. The mirror mount assembly of claim 13 wherein the means for mounting the second bracket is at least one of a split ring, a ring, and a C-clip.

19. The mirror mount assembly of claim 13 further comprising a fastener constructed to pass through the means for mounting the second bracket and engage the surface.

20. The mirror mount assembly of claim 13 wherein a maximum diameter of the nipple substantially matches a maximum diameter of the first conical portion of the opening of the second bracket.
